(19) United States
(12) Patent Application Publication
(10) Pub. No.: US 2004/0123075 A1
(43) Pub. Date: Jun. 24, 2004

(54) Extended loop prediction techniques

(76) Inventor: Yoav Almog, Haifa (IL)

Correspondence Address: Jeffrey S. Draeger, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/324,951

(22) Filed: Dec. 19, 2002

(51) Int. Cl. G06F 9/30

(52) U.S. Cl. 712/207; 712/239; 712/241

(57) ABSTRACT

Extended loop prediction techniques. One embodiment of an apparatus utilizing disclosed techniques includes at least one execution unit and a prefetcher utilizing a variable length loop detector to fetch a control sequence for the execution unit. The variable length loop detector is capable of predicting branches for loops having changing iterations counts.

### BACKGROUND

1. Field

The present disclosure pertains to the field of processing and/or microprocessors, and particularly to predicting changes in the flow of control of processing.

2. Description of Related Art

Modem processing devices such as microprocessors attempt to fetch instructions and data in advance of their actual usage in order to avoid delays in processing. Such advanced fetching (often referred to as prefetching) may be highly advantageous because retrieving instructions and/or data from memory is often a significant bottleneck in the throughput of processing systems. Such advanced fetching, however, typically requires that some prediction be made as to the flow of events within the processor. Branch predictors are often used to perform such predictions.

A variety of branch prediction techniques have been proposed. Such techniques typically maintain some history of previous behavior of branches (e.g., a branch history table). For example, a counter may be used to track the bias of a particular branch instruction. The counter may count how many times the branch is taken versus how many times the branch is not taken. The more likely choice may then be used as the prediction when the branch is once again encountered.

The use of such a table mechanism is of limited usefulness for loops. A loop is an instruction sequence which executes a number of times (in some cases a predetermined number, in other cases a variable number). By definition, a finite loop ends at some point in time. Thus, even though the branch prediction may be correct many times while the loop continues, the prediction that the loop should again be executed eventually fails when the loop ends.

As microprocessors become more deeply pipelined, the penalty of misprediction typically increases because a mispredict may require a pipeline flush. Therefore, modem microprocessors employ sophisticated branch prediction techniques to decrease the likelihood or frequency of mispredicts. Already, branch misprediction rates are quite low. Thus, the significance of each mispredicted branch for a loop may be quite high.

Accordingly, the prior art also includes loop detectors. One example of a loop detector has a learning mode and an active mode. During the learning mode, the loop detector observes the number of loop iterations (NLI) for a branch by counting the number of times a branch is executed with the same branch direction, the branch default direction (BDD). During the learning period, the loop detector prediction is set to the default direction of the branch. Once the branch is executed with a reversed direction, the accumulation process ends, and the loop detector stores the NLI of the branch and switches to the active mode for that branch.

When active, the loop detector tracks the current loop iteration (CLI) by advancing a CLI counter for each execution of the branch. When the value of the CLI reaches the value of the NLI, it is reset to zero. The loop detector uses the NLI, CLI and BDD to generate branch predictions for the branch. In particular, when the CLI value is smaller than the NLI value, the prediction for the branch is set to the BDD. Otherwise, when the CLI equals NLI, the branch predictor assumes that the branch is the last iteration of the loop, and the branch predictor predicts the opposite direction of the BDD. Thus, a finite loop that utilizes the same loop count each time encountered may be predicted according to one prior art technique.

Further techniques to improve such branch predictors and loop detectors may help reduce branch mispredictions and in some cases may expedite processing and/or avoid the increasing penalties of flushing a processor pipeline due to branch mispredictions.

### BRIEF DESCRIPTION OF THE FIGURES

The present invention is illustrated by way of example and not limitation in the Figures of the accompanying drawings.

FIG. 1 illustrates one embodiment of a system utilizing a variable length loop predictor.

FIG. 2 illustrates a method for predicting branches of variable length loops according to one embodiment.

FIG. 3 illustrates one embodiment of branch prediction logic including a variable length loop predictor.

FIG. 4 illustrates a prediction diagram according to one embodiment.

FIG. 5 illustrates a mode or state diagram for one embodiment.

### DETAILED DESCRIPTION

The following description describes embodiments of extended loop prediction techniques. In the following description, numerous specific details such as mode names, variable names, table arrangements and system configurations are set forth in order to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

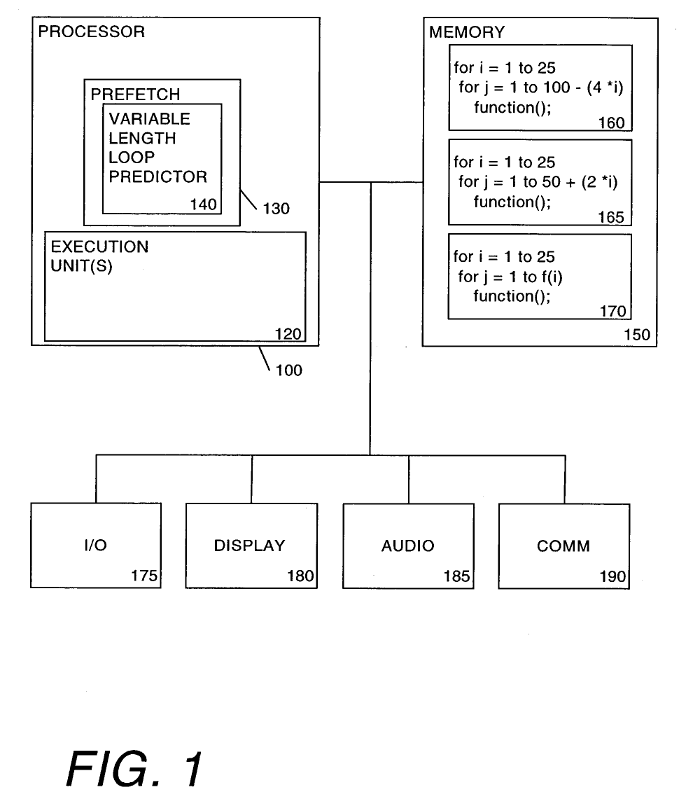

FIG. 1 illustrates one embodiment of a system utilizing a variable length loop predictor. In the embodiment of FIG. 1, a processor 100 is illustrated as having execution unit(s) 120 and prefetch logic 130 which includes a variable length loop predictor 140. The execution unit(s) 120 may include one or more separate sets of execution logic or execution modules. The execution unit(s) 120 may include various scheduling and pipelining units and/or may include discrete units such as floating point or integer calculation units. Generally, the execution unit(s) may be any hardware or a hardware, software, and/or firmware combination that utilizes fetching logic to fetch a control sequence or an instruction stream. In some embodiments, various elements such as the prefetch logic 130 may be intermingled partially or wholly with the execution unit(s) 120.

The processor 100 may be any of a variety of different types of processors, so long as the processor executes an instruction stream or follows a control sequence and therefore utilizes fetching of data or control information. For example, a general purpose processor may utilize disclosed loop prediction techniques. Additionally, special purpose processors, network processors, embedded processors, etc., may utilize disclosed loop prediction techniques.

A memory 150 is shown as coupled to the processor 100. The memory 150 may be a system memory external to the processor in one embodiment. In another embodiment, the memory 150 may be integrated on a single device (e.g., an integrated circuit) with the processor and/or may be a cache memory. The memory 150 and the processor 100 are coupled together such that the processor can read from and write to the memory 150. Direct or indirect coupling via a variety of buses, links (e.g., serial or point-to-point links), or other known or otherwise available couplings may be utilized for this connection and other connections illustrated in FIG. 1.

Also shown in FIG. 1 are an I/O device 175, a display device 180, an audio device 185 (may be input and/or output), and a communication interface 190. Each of these devices is operatively coupled to the processor 100 and at least partially controllable by the processor. Instructions in programs in the memory 150 may be executed by the processor 100 to control these devices. The I/O device may be a device such as a keyboard, a mouse, or some other user input device to allow the system to receive external inputs. A user need not necessarily be involved. The display is another component shown in the embodiment of FIG. 1, which allows processing output to be displayed to one or more users. The communication interface 190 may be a network card, a modem type interface, a wireless communication interface, or any known or otherwise available communications interface. Instructions executable by the processor may be downloadable via the communication interface 190. A machine readable medium (either a transmission medium or a storage medium) may carry such instructions for execution by the processor.

In the embodiment illustrated in FIG. 1, the memory 150 stores three example loop sequences, each indicating a nested loop situation. Code sequences 160 and 165 are “triangular” loops. A triangular loop is a sequence that has an inner loop count which either linearly increases or linearly decreases with iterations of the outer loop. For example, sequence 160 has an outer loop variable of i and an inner loop variable of j. The iteration count for the inner loop of sequence 160 decreases at a rate of four times the outer loop variable i. Thus, the loop count for j decreases by four for each iteration of the outer loop.

If a branch predictor could only predict static loops, then the branch predictor would likely wrongly predict branches for triangular loops. In other words, a loop predictor that assumes a static loop count may not be able to predict branches for triangular loops. In contrast, a variable length loop predictor such as the loop predictor 150 shown in FIG. 1 may learn how a loop length is changing and thereby accurately predict when branches occur.

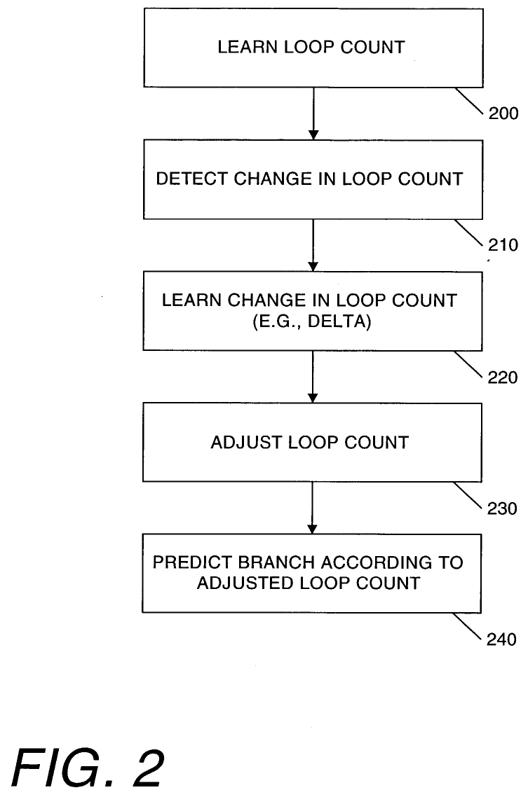

The flow diagram of FIG. 2 illustrates one embodiment of a variable length loop prediction technique, which will be explained considering the sequence 160 as an example. As indicated in block 200, first the original loop count is determined (for the inner loop). Thus, the outer loop using i as a variable is first initialized at one. Next the inner loop also initializes j to one, and begins to iterate, executing the function “function( )” in each iteration. Clearly, more elaborate loops and a variety of functions in one or both loops may be used in various embodiments.

Each time the inner loop completes (each time “function( )” is executed), the inner loop increments j and branches to its start, until its (variable) terminal count is reached. Thus, numerous branches are taken in a first direction, a branch default direction (BDD). When the terminal count is reached, the reverse direction is taken. The initial loop count may be assumed to be the number of iterations until the reverse direction is taken by the branch at the end of the inner loop. Thus, the loop predictor 150 may learn the loop count, also referred to as a Number of Loop Iterations (NLI).

During the first iteration of the outer loop of the sequence 160, the inner loop counter j runs from one to ninety-six. During the second iteration of the outer loop, the inner loop counter j runs from one to ninety-six. Thus, if the predictor 150 predicts a loop with the same loop count (NLI), then the predictor 150 will mispredict a branch. In particular, when the ninety-second iteration of the inner loop occurs, the predictor will wrongly predict another loop iteration. This misprediction signals a change in the loop count, as detected in block 210. The misprediction, or in the case of more complex iteration count changes several mispredictions, may be used to learn the change in loop count as indicated in block 220. A “delta” may be a single value (positive or negative) for the case of linearly increasing or decreasing (triangular) loops. The delta may be a more complex function in the case where such complex or non-linear relationships are tracked, in which case two or more mispredictions may be required to learn the delta.

For the example of sequence 160, the delta is a linear decrease of four. Once this delta is learned in block 220, then the loop predictor 150 may adjust the loop count as indicated in block 230. In this case, once this delta is learned, the loop predictor 150 decreases by four the predicted loop count for the inner loop with each iteration of the outer loop. Then, as indicated in block 240, a branch of the reverse of the default branch direction is predicted when the adjusted loop count is reached, successfully predicting the branch direction while the variable length loop continues.

As another example, the sequence 165 has an inner loop which increases as the outer loop count increases. In the sequence 165, the inner loop count increases by two for each iteration of the outer loop. Again, this delta may be learned by the loop predictor 150 to predict this linearly increasing triangular loop. As a final example, the loop predictor 150 may be more sophisticated and may learn more complex loop length dependencies. Sequence 170 shows a code sequence with an inner loop which is a function of the outer loop length, but not necessarily a linear function. The function f(i) in sequence 170 may be generalized to indicate that the inner loop j may be any function of the outer loop count i. The start or end count of the loop may be a function of i, and/or the iteration count may be a linear or non-linear function of i. One of skill in the art will recognize that there is a tradeoff between the amount of logic or functionality needed to detect and store such relationships, and it may or may not be worth detecting and storing complex relationships in different embodiments. For example, a sequence of mispredictions may be used to learn the progression of the inner loop count. Basic known and otherwise available pattern recognition techniques may be used to compute such relationships.

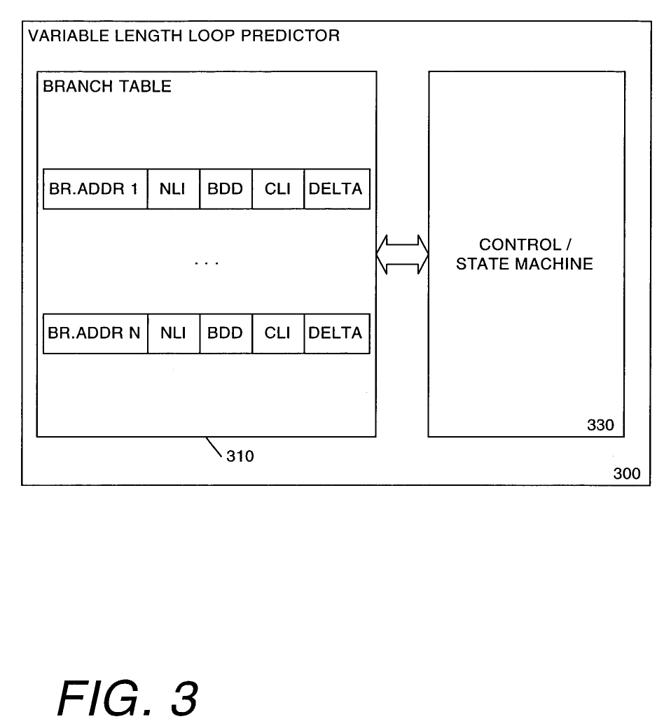

FIG. 3 illustrates details of structures that may be used to assist in tracking and/or predicting variable length branches. In the embodiment of FIG. 3, a variable length loop predictor 300 includes a branch table 310 and a control module 330. The control module 330 may be control logic or code and/or may include a state machine in some embodiments. As illustrated, a plurality of entries track information for branches. The entries are tagged by a branch address indicator. The branch address indicator indicates some or all of a branch address. In some cases, a hash of address bits may be used. Also, the branch table may be implemented as a content-addressable memory (CAM) such that entries may be quickly looked up in the table based on the branch address. It may be advantageous to use a partial branch address in some cases to avoid waiting for address translations, to limit the needed storage space, etc.

In the embodiment illustrated in FIG. 3, each branch entry in the branch table 310 includes a branch field (e.g., BR.ADDR 1-BR.ADDR N). In this embodiment, each branch entry also stores a number of loop iterations (NLI), a branch default direction (BDD), a current loop iteration count (CLI), and a delta. As previously mentioned, the delta may be a value or in some cases a function. In some embodiments, the CLI value may not be stored in the branch table, but rather may be stored within the control module if a limited number of loops are learned concurrently.

The various loop prediction techniques and/or hardware disclosed herein may of course be used in conjunction with other branch prediction techniques. In some embodiments, variable length loop prediction may only be enabled under certain circumstances. For example, a branch predictor may over time decide that a particular branch is a difficult-to-predict branch and therefore may attempt to predict the branch prediction for that branch using a loop predictor and/or a loop predictor capable of predicting variable length loops. Moreover, branch tables may mix branches predicted by various techniques, and the particular entries in the branch table may or may not be dedicated to storing a particular type of branch prediction information. In other words, the branch table may provide a storage area associated with particular branch addresses, and the storage area may be used to store different types of information at different times.

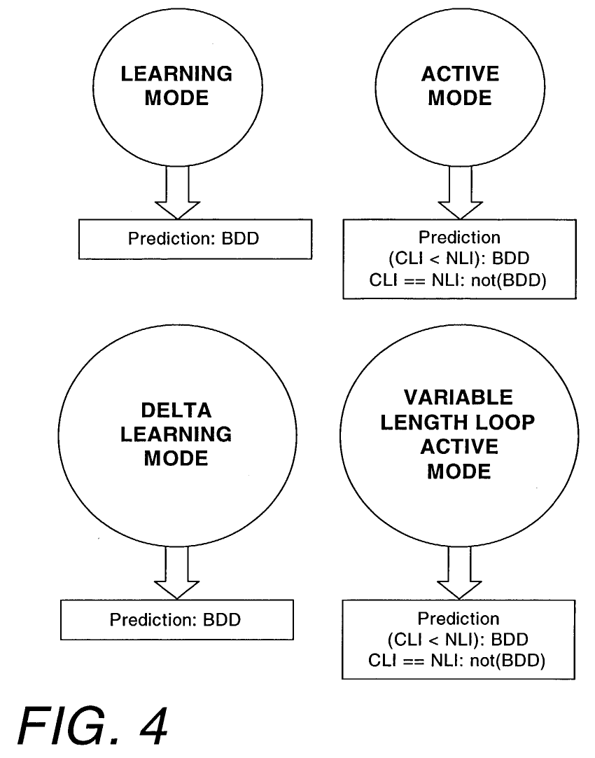

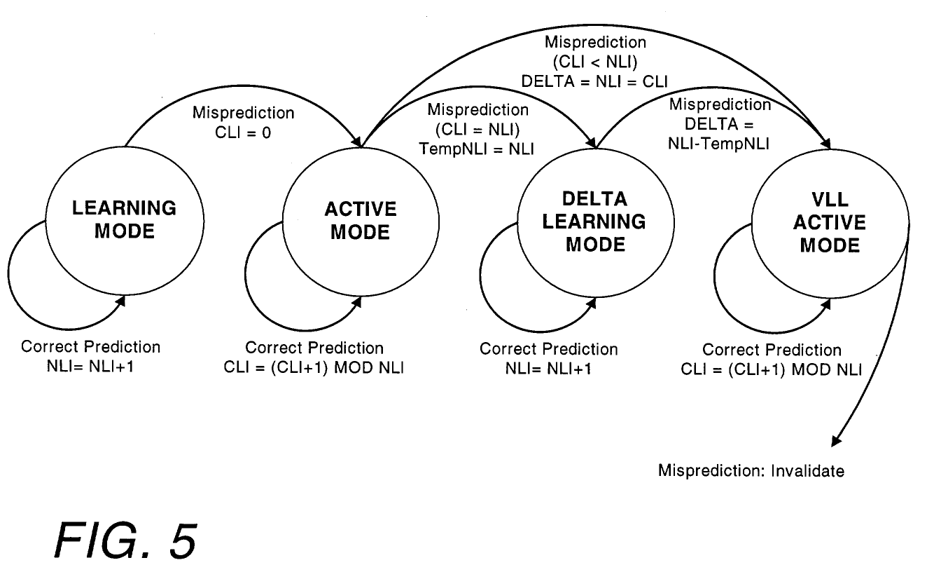

FIGS. 4 and 5 illustrate prediction diagrams and a state diagram according to one embodiment. The embodiment of FIGS. 4 and 5 may be used to predict linearly increasing or decreasing loop iteration counts. For each mode (each mode may be a state in a state machine in some embodiments), FIG. 4 illustrates the predicted output, and FIG. 5 illustrates mode transitions. Both assume that the loop predictor is active. As illustrated in FIG. 4, from a learning mode, the branch default direction is predicted. To explain the mode transitions, the code sequences 160 and 165 from FIG. 1 will again be considered.

For sequence 160, the learning mode is entered for a branch associated with the inner (j) loop. The number of loop iterations (NLI) is initialized to one to begin predicting the loop count. As shown in FIG. 4, the learning mode predicts the branch default direction. With each correct prediction, as shown in FIG. 5, NLI is increased, and the predictor remains in the learning mode. If a mispredict occurs, then the learning mode is exited and the active mode is entered. Also, the current loop iteration count (CLI) is set to zero as shown in FIG. 5. In the active mode, CLI is incremented with correct predictions. CLI is basically reset to zero when NLI is reached, or the value CLI MOD NLI (the remainder) may be considered.

As shown in FIG. 4, in the active mode, the branch prediction is the default direction if CLI is less than NLI. Thus, the prediction is that the loop continues until NLI is reached. Once NLI is reached, the active mode predicts the reverse of BDD. Thus, the learning mode and the active mode together can be used to correctly predict loops with static iteration counts.

However, in the case of a triangular loop, or other loops than a loop with a variable iteration count, the active mode will mispredict. There are two possibilities when this mispredict occurs. First, the mispredict may occur because a prediction of the branch default direction was inaccurate. In this case, the loop count is decreasing because a mispredict occurred before the loop got to the previous NLI. In the case of sequence 160, a decreasing loop count is detected because the variable j counts from one to a value that decreases by four times the outer loop count (i).

Thus, for sequence 160, if the first iteration of the outer loop sets NLI to ninety-six, then the second iteration causes a mispredict (CLI<NLI) and the predictor moves to the variable length loop (VLL) active mode as shown in FIG. 5. The VLL active mode may be entered in response to this mispredict because the predictor speculates that the difference between the CLI when the mispredict occurs and the NLI from the previous iteration is the delta, and that the delta represents a linear change that will be repeated in future iterations.

Once in the VLL active mode, when correct predictions occur, CLI continues to be incremented the predictor remains in the VLL active mode. CLI may be either reset when the inner loop completes or may be calculated as a remainder of CLI divided by NLI (CLI=(CLI+1) MOD NLI). NLI is updated at each iteration of the inner loop such that the VLL active mode continues to predict subsequent iterations of the linearly changing inner loop. While in the VLL active mode, the predictor predicts the branch default direction if CLI is less than NLI and the reverse of the branch default direction if CLI equals NLI, as shown in FIG. 4. If a mispredict occurs, the VLL active mode invalidates the branch entry, assuming that it cannot be predicted assuming either a static loop model or a linearly increasing or decreasing loop model. Additional states may be added to track second and additional mispredicts if it desirable to attempt to predict more complex loop iteration relationships. For example, a delta may be computed for the sequence 170, which may implement a non-linear relationship of the inner loop count to outer loop iterations.

Sequence 165, on the other hand, includes a linearly increasing inner loop. The terminal count of j of the inner loop of sequence 165 linearly increases as fifty plus twice the outer loop variable i. According to the embodiment of FIGS. 4 and 5, the learning mode and active mode may be activated as previously discussed. First, the learning mode learns the iteration count of the first iteration of the inner loop, but then when that iteration count is used to predict the branch direction for the second iteration, an incorrect prediction occurs. In particular, in the sequence 165, the active mode continues to predict that the branch default direction until the NLI from the previous iteration is reached, and then predicts the reverse direction (see FIG. 4). However, since the inner loop counts to a higher value in subsequent iterations, the prediction of the reverse branch default direction is inaccurate. In this case, a misprediction with CLI equal to NLI occurs, and the delta learning mode is entered as indicated in FIG. 5. Additionally, a temporary storage location (e.g., tempNLI) may be used to store the NLI value when the mispredict occurs.

In the delta learning mode, the predictor predicts the branch default direction as indicated in FIG. 4. The predictor remains in the delta learning mode and increments NLI as long as correct predictions occur, but exits the delta learning mode when a misprediction occurs, as shown in the transition diagram of FIG. 5. When a misprediction occurs and the predictor transitions to the VLL active mode, the delta value may be calculated as the NLI (at which the mispredict occurs) minus the tempNLI value at which the previous mispredict occurred. Thereafter, the delta being calculated, the predictor may proceed in the VLL active mode as previously described with respect to sequence 165.

Thus, techniques for extended loop prediction techniques are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

It is to be understood that any of the various “logic blocks” or “blocks” might be implemented as software or firmware, or any combination of hardware, firmware, software, and the like. Additionally, various blocks in flowchart form need not necessarily be performed sequentially, but may at times be performed in different orders or partially or fully in parallel.

Moreover, a design may go through various stages, from creation to simulation to fabrication. Data representing a design may represent the design in a number of manners. First, as is useful in simulations, the hardware may be represented using a hardware description language or another functional description language Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit for at least one process technology. In any representation of the design, the data may be stored in any form of a machine readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) embodying techniques of the present invention.

What is claimed is:

1. An apparatus comprising:
an execution unit;
a prefetcher to prefetch a control sequence for said execution unit, said prefetcher comprising a variable length loop detector, said variable length loop detector to predict a branch for a loop having a changing iteration count.

2. The apparatus of claim 1 wherein said variable length loop detector is capable of tracking and predicting branches for a linearly increasing iteration count or a linearly decreasing iteration count.

3. The apparatus of claim 1 wherein said variable length loop detector comprises at least one storage location to store per branch data indexed by a branch address indicator, said branch data comprising:
a number of loop iterations;
an iteration count change;
a default branch direction.

4. The apparatus of claim 3 wherein said variable length loop detector further comprises:
logic to calculate an iteration count change in response to a mispredict and to store the iteration count change into the at least one storage location.

5. The apparatus of claim 1 wherein said variable length loop detector operates in one of a delta learning mode and a variable length loop active mode.

6. The apparatus of claim 5 wherein said variable length loop detector also is to predict static loops, said variable length loop detector also to operate in a learning mode and an active mode for static loops, wherein said delta learning mode and said variable length loop active mode are entered in response to mispredicts from the active mode.

7. The apparatus of claim 1, wherein said apparatus is in the form of data for at least one process technology, said data defining an integrated circuit stored on a machine readable medium, which when fabricated, forms the integrated circuit.

8. The apparatus of claim 1, wherein said apparatus is a system, the system further comprising:
a memory to store a plurality of instructions as the control sequence for fetching by the prefetcher, said plurality of instructions comprising:
an outer loop having an outer loop count;
an inner loop, said inner loop having a variable length which is a function of the outer loop count, wherein said variable length loop detector is to detect the variable length and to correctly predict a subsequent branch of the inner loop as taken.

9. The system of claim 8 wherein said memory is an external memory, the system further comprising:
an input/output device;
a display;
an audio output;
a communications interface.

10. An apparatus comprising:
a branch history table, said branch history table to store, for each of a plurality of branches, a branch address indicator and a delta, the delta indicating a difference between numbers of iterations in successive iterations through a loop;
control logic coupled to the branch history table, said control logic to predict a branch direction as a function of the delta.

11. The apparatus of claim 10 wherein said delta is a number.

12. The apparatus of claim 10 wherein said delta is a function describing the difference between numbers of iterations in successive iterations through the loop.

13. The apparatus of claim 10 wherein said branch history table is further to store a branch default direction and a number of loop iterations count.

14. The apparatus of claim 13 wherein said control logic comprises a state machine operable in a plurality of modes, the plurality of modes comprising:
a learning mode;
an active mode;
a delta learning mode;
a variable length loop active mode.

15. The apparatus of claim 14 wherein in said learning mode, said control logic determines a number of loop iterations of a loop, wherein in said active mode, said control logic predicts that the loop has completed and that the branch default direction is reversed in response to the number of loop iterations being reached, wherein in said delta learning mode, said control logic continues using said branch default direction until a mispredict is reached to determine the delta, and wherein in said variable length loop active mode, said control logic predicts that the loop has completed and that the branch default direction is reversed in response to a number of loop iterations adjusted by the delta being reached.

16. The apparatus of claim 15 wherein said state machine transitions from said learning mode to said active mode in response to a misprediction and remains in said learning mode in response to a correct prediction, wherein said state machine transitions from said active mode to said delta learning mode in response to a second misprediction if a current loop iteration count equals the number of loop iterations and remains in said active mode in response to a second correct prediction, wherein said state machine transitions to said variable length loop active mode from said active mode if the second mispredict occurs and the current loop iteration count is less than the number of loop iterations, wherein said state machine transitions from the delta learning mode to the variable length loop active mode in response to a third misprediction and remains in the delta learning mode in response to a third correct prediction.

17. A method comprising:
determining a loop iteration count for a branch;
detecting a deviation from said loop iteration count;
predicting a branch direction reversal after an adjusted loop iteration count, wherein said adjusted loop iteration count is said loop iteration count adjusted in accordance with said deviation.

18. The method of claim 17 wherein detecting the deviation comprises:
detecting a mispredict;
characterizing the deviation.

19. The method of claim 18 further comprising:
if the mispredict is a mistaken prediction of a reversal of a branch default direction, then entering a delta learning mode to determine a delta;
if the mispredict is a mistaken prediction of the branch default direction, then entering a variable length loop active mode.

20. The method of claim 19 wherein said delta is a fixed number, and wherein said adjusted loop iteration count may be adjusted upwardly or downwardly by said fixed number in each iteration of an outer loop.

21. A method comprising:
predicting a branch first direction in a first learning mode;
predicting the branch first direction if a current loop iteration count is less than a number of loop iterations and predicting a branch second direction if the current loop iteration count is equal to the number of loop iterations in a first active mode;
predicting the branch first direction in a second learning mode;
predicting the branch first direction if the current loop iteration count is less than an adjusted number of loop iterations and predicting the branch second direction if the current loop iteration count is equal to the adjusted number of loop iterations in a second active mode.

22. The method of claim 21 wherein the adjusted number of loop iterations is derived from the number of loop iterations and a delta determined either in the second learning mode or from a misprediction in the first active mode.

23. The method of claim 22 further comprising:
transitioning from the first learning mode to the first active mode in response to a first misprediction;
remaining in the first learning mode in response to a first correct prediction;
transitioning from the first active mode to the second active mode in response to a second misprediction and the current loop iteration count being less than the number of loop iterations;
transitioning from the first active mode to the second learning mode in response to a third misprediction and the current loop iteration count being equal to the number of loop iterations;
remaining in the second learning mode in response to a second correct prediction;
transitioning from the second learning mode to the second active mode in response to a fourth misprediction;
remaining in the second learning mode in response to a third correct prediction;
exiting the second active mode in response to a fifth misprediction;
remaining in the second active mode in response to a fourth correct prediction.
